(19) United States
(12) Patent Application Publication
(10) Pub. No.: US 2012/0020326 A1
(43) Pub. Date: Jan. 26, 2012

(54) METHOD AND APPARATUS FOR EFFECTING A HANDOFF IN A FREQUENCY-DIVISION MULTIPLEX NETWORK

(76) Inventors: Hang Zhang, Nepean (CA); Jianglei Ma, Kanata (CA); Ming Jia, Ottawa (CA)

(21) Appl. No.: 13/001,298

(22) PCT Filed: Jul. 3, 2009
(86) PCT No.: PCT/CA09/00915

§ 371 Date: Oct. 11, 2011

Related U.S. Application Data
(60) Provisional application No. 61/078,267, filed on Jul. 3, 2008.

(51) Int. Cl. H04W 36/00

(52) U.S. Cl. 370/331

(57) ABSTRACT

In a frequency division multiplex network, a method involves employing spread-spectrum communication in addition to frequency-division multiplexing for facilitating handoffs. A portion of the total transmission resources is designated for spread-spectrum frequency division multiplexed signals. A communication between a base station and a mobile station takes place over a transmission resource block in the reserved designated portion at the moment of handoff and uses spread-spectrum frequency-division signals. A base station receiving the handoff can communicate over the transmission resource block even if it is already communicating over the transmission resource block since the communication is spread-spectrum encoded.

### CROSS REFERENCE TO RELATED APPLICATIONS

The present application claims the benefit under 35 USC 119(e) of U.S. Provisional Application Ser. No. 61/078,267, filed Jul. 3, 2008 in the United States of America, the disclosure of which is incorporated herein by reference in its entirety.

### FIELD OF THE INVENTION

The present invention relates to the field of frequency-division multiplexed networks, and more particularly to the technologies for effecting handoffs in frequency-division multiplexed networks.

### BACKGROUND OF THE INVENTION

In telecommunications networks, a handoff refers to the act of transferring control of communication with a remote entity from one station to another. For example, in a wireless network comprising a network of base stations, a when a mobile station moves from an area serviced by a first base station to an area serviced by a second base station, a handoff is effected whereupon the connection between the mobile station and the first base station is severed and resumed between the mobile station and the second base station. A handoff is sometimes referred to as a handover.

A soft handoff refers to a handoff wherein the communication between base station and mobile station is not transferred instantly from one base station to another, but rather undergoes a soft handoff period during which the mobile station is in communication with both the first base station and the second base station before communication with the first base station is severed.

Soft handoffs have many benefits over traditional handoffs, however their implementation can be problematic in networks relying on frequency-division multiplexing, particularly in orthogonal frequency-division multiple-access (OFDMA) networks. Traditionally, in OFDMA systems, soft handoffs are implemented by more than one base station transmitting the same information on the same OFDMA space using the same scrambling code. For such a procedure, it is necessary to coordinate which resource space is to be used in the soft handoff to avoid, for example, that the same frequency be used at the same time in a same location (e.g. one base station's range) by two different entities. Such coordination requires a centralized resource controller and can be very complicated. In particular, a centralized scheduling is required to coordinate between multiple base stations the transmission resources (time-frequency-space) used in the soft handoff for interference avoidance, which can be very complex. Furthermore, mobile stations need to be made aware of the soft handoff and parameters thereof, which incurs a high communications overhead, in particular for dense networks such as microcell or picocell networks where soft handoff conditions occur frequently.

In the context of the above, it can be appreciated that there is a need in the industry for an improvement in OFDMA communications to permit more efficient implementation of soft handoffs.

### SUMMARY OF THE INVENTION

In accordance with a first broad aspect, the present invention provides a method for execution by an apparatus comprising sending a first signal while not during a soft handoff, the first signal being a frequency division multiplexed signal comprising several subcarrier components. The method further comprises sending over a second plurality of frequency subcarriers a second signal during the soft handoff, the second signal being a spread-spectrum frequency-division multiplexed signal comprising several subcarrier components.

In accordance with a second broad aspect, the present invention provides an apparatus for use in a communication network. The apparatus comprises a transmission interface and a processing element in communication with the transmission interface. The processing element is operative for causing the transmission interface to emit a frequency-division multiplexed signal comprising several subcarrier components while not during a soft handoff. The processing element is further operative for causing the transmission interface to emit a spread-spectrum frequency-division multiplexed signal during the soft handoff, the spread-spectrum frequency-division multiplexed signal comprising several subcarrier components.

In accordance with a third broad aspect, the present invention provides a method for execution by an apparatus comprising receiving a first signal prior to a soft handoff, the first signal being a frequency-division multiplexed signal comprising several subcarrier components. The method further comprises receiving a second signal after the soft handoff, the second signal being a frequency-division multiplexed signal comprising several subcarrier components. The method further comprises receiving a third signal during the soft handoff, the third signal being a spread-spectrum frequency-division multiplexed signal comprising several subcarrier components.

In accordance with a fourth broad aspect, the present invention provides an apparatus for use in a communication network. The apparatus comprises an input interface receiving signals and a processing element in communication with the input interface. The processing element is operative for while not during a soft handoff, demodulating a first signal received by the input interface, the first signal being a frequency-division multiplexed signal comprising several subcarrier components. The processing element is further operative for during a handoff, de-spreading and demodulating a second signal received by the input interface, the second signal being a spread-spectrum frequency-division multiplexed signal comprising several subcarrier components, the de-spreading being performed using a spreading code.

In accordance with a fifth broad aspect, the present invention provides a method comprising sending first signal prior to detecting a handoff condition, the first signal being a frequency-division multiplexed signal comprising several subcarrier components. The method further comprises detecting the handoff condition. The method further comprises subsequent to detecting the handoff condition, sending a second signal, the second signal being a spread-spectrum frequency-division multiplexed signal comprising several subcarrier components.

These and other aspects and features of the present invention will now become apparent to those of ordinary skill in the art upon review of the following description of specific embodiments of the invention and the accompanying drawings.

### BRIEF DESCRIPTION OF THE DRAWINGS

A detailed description of examples of implementation of the present invention is provided hereinbelow with reference to the following drawings, in which:

FIG. 1 shows a frequency-division multiplexed network comprising a homogeneous zone in accordance with a non-limiting embodiment;

FIG. 2 shows a portion of the homogeneous zone shown in FIG. 1;

FIG. 3 shows a representation of the total transmission resources available to a base station in accordance with a non-limiting embodiment;

FIG. 4 shows a flow chart of the methods involved in a soft handoff in accordance with a non-limiting embodiment;

FIG. 5 shows a block diagram of a base station in the homogeneous zone shown in FIG. 2; and

FIG. 6 shows a block diagram of a mobile station in the homogeneous zone shown in FIG. 2.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

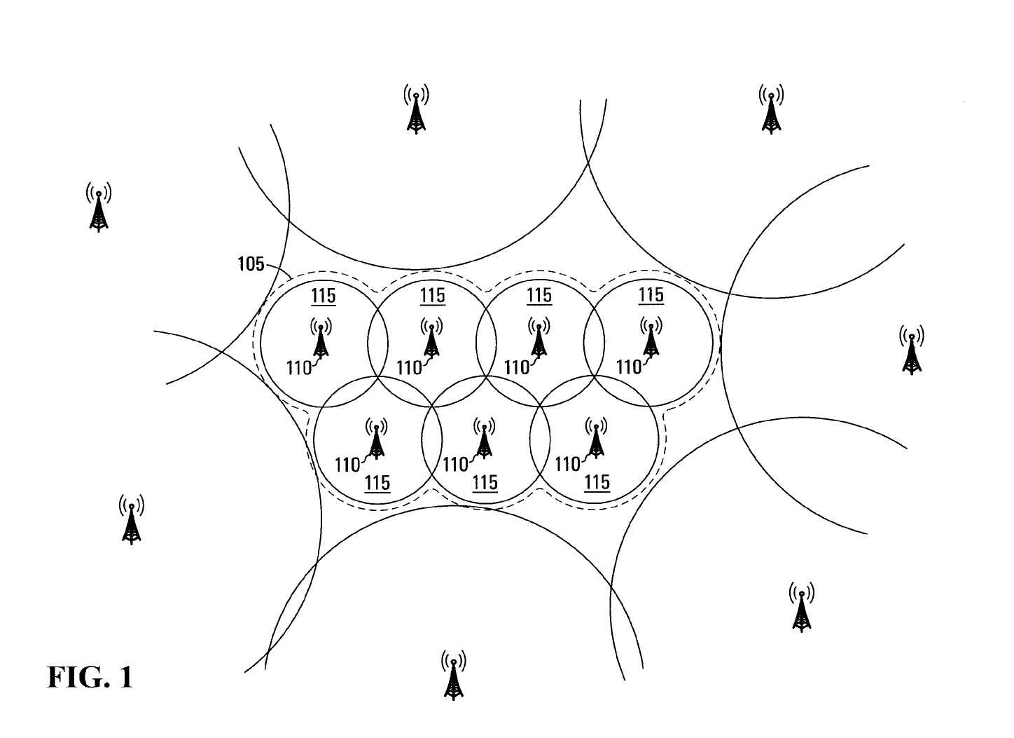

FIG. 1 illustrates an OFDMA network 100 in accordance with a first non-limiting example. The OFDMA network 100 comprises a plurality of base stations 110, each serving a respective service area 115 wherein they can establish communications with mobile stations 120. The OFDMA network 100 can be any network comprising a plurality of base stations 110 communicating using orthogonal frequency-division multiplexed signal with at least one mobile station that can be found at a given time within the service area 115 of any one of at least two of the plurality of base stations 110.

Within the OFDMA network 110, communication takes place in a frequency-division multiplexed manner. That is, the frequency spectrum is divided into a plurality of subcarriers and data is transmitted over several multiple frequency subcarriers in parallel streams. As such, a single signal sent over the OFDMA network 110 may comprise several subcarrier components. In the example provided here, the OFDMA network 110 is implements orthogonal frequency multiple access communication (OFDMA), whereby multiple access is achieved by assigning at each base station 110 a subset of frequency subcarriers to individual mobile stations 120. However it is to be understood that the network could employ non-OFDMA OFDM, wherein multiple access may be provided by any suitable means, such as using time division multiplexing techniques. Alternatively, multiple access may not be implemented at all, if there is only one mobile station 120.

Regardless of whether OFDM or OFDMA is used, the signals transmitted within OFDMA network 110 can be time division multiplexed. With time division multiplexing, time is divided into a single sequentially re-occurring time frame composed of multiple time slots located at constant relative positions within the time frame. A time division multiplexed signal is assigned one or more time slots and is transmitted only during its respective time slot(s) at each recurring time frame. In the OFDMA network 110, the overall transmission resources of each base station can be divided into frequency subcarriers and, optionally, time slots, such that a signal being transmitted over the network may be assigned frequency subcarriers and a time slot. Other signals can be simultaneously transmitted over the same frequency subcarriers but over different time slots, or over the same timeslots but over different subcarriers. Multiple-access is thus provided in a two-dimensional plane of transmission resources.

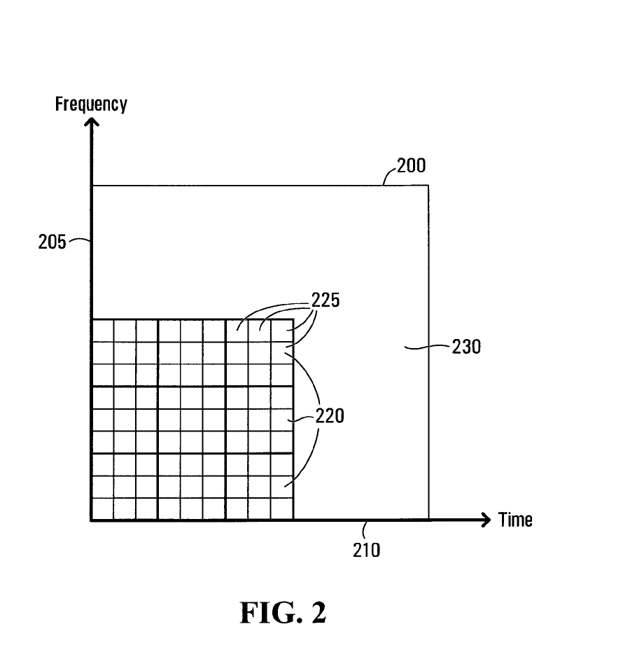

The term transmission resources as used herein can designate any aspects attributable to a signal allowing it to be transmitted in a manner differentiating it from another signal. Thus transmission resources can include frequency subcarriers, time slots, spatial location and a CDMA code. Each such aspect can define a dimension in which the transmission resources are divided. For example, as shown in FIG. 2, the transmission resources may be defined within a two-dimensional space, in which one dimension comprises frequency subcarriers and the other time slots. In this two dimensional space, transmission resources can be divided into segments comprising frequency and time coordinates, each segment being assignable to a signal. It is possible to add additional dimensions to the transmission resource space by additionally dividing signals with CDMA code coordinate or a spatial restrictions.

In the particular example shown here, the OFDMA network 110 comprises fixed base stations 110 that each have a service area 115 of fixed shape, size and location. However, it is to be understood that the bases stations 110 can also be mobile themselves, and the service area 115 that they each service may be variable. For example, in an alternative embodiment, base stations 110 could be non-geostationary satellites that move relative to a mobile station 120 on earth. Alternatively, base stations 110 may vary the strength/sensitivity of their transmission/reception hardware such that the service areas 115 they cover change over time. In either of these examples, a mobile station 120 may actually be geographically fixed and merely move relative to the service areas 115 or to base stations 110 in the OFDMA network 110.

It should be understood that base stations 110 and mobile stations 120 are not limited by any structure or application, but can be any elements of a network operating as described herein. Likewise, network 100 is not limited to any particular type of network. For example, base stations 110 can take the form of access points in a wireless local area network (LAN). In this example, the OFDMA network 110 may be the wireless LAN and there may be one or more mobile stations 120 taking the form of computers, IP cell phones, or other devices. Alternatively, base stations 110 may be cell phone base stations in a cellular telephony network including cellular phones as mobile stations 120.

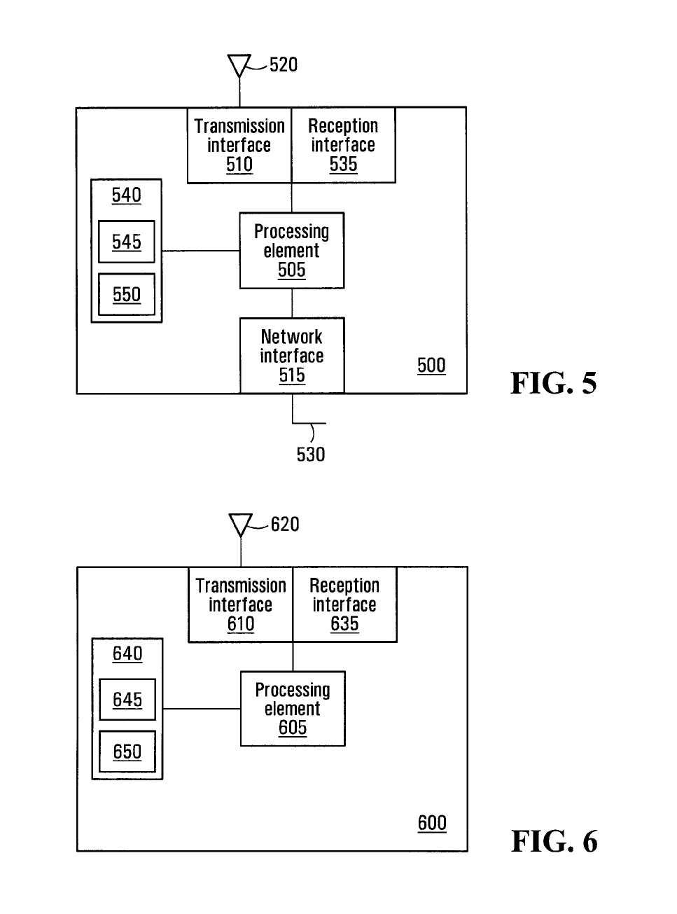

Base stations 110 communicate with mobile stations 120 through an interface. The base stations 110 may comprise antennas for causing signals to be sent as radio frequency waves or may simply comprise an interface in communication with an antenna or antenna-comprising element. FIG. 5 illustrates a non-limiting embodiment of a specific base station 500. The interface is adapted for sending signals intended for mobile stations 120. In this embodiment, the specific base station 500 is connected to an antenna 520 through a transmission interface 510 and a reception interface 535. The transmission interface 510 provides output signals to the antenna, while the reception interface 535 receives input signals from the antenna. Of course, the two interfaces could each have their own antennae or could be combined into a single component. The specific base station 500 is controlled by a processing element 505 that is in communication with the transmission interfaces and that is operative to perform the actions described herein. Each base station may also be capable of communications with other base stations or other network elements such as a centralized server and in the example shown here the specific base station 500 comprises a network interface 515 for such communications. The specific base station 500 also comprises a memory 540 with memory components 545 and 550 that serve the function described herein below.

Each mobile station 120 comprises an input interface for receiving signals from base stations 110. In an example shown on FIG. 6, a specific mobile station 600 is connected to an antenna 620 and comprises a transmission interface 610 for sending signals to base stations 110. The specific mobile station 600 also comprises a reception interface or receiving signals from the antenna. Here too an individual antenna could be provided for each interface or the interfaces could be combined. The specific mobile station 500 is controlled by a processing element 605 that is connected to the interfaces and implements the actions described herein. The specific mobile station 600 also comprises a memory 640 with memory components 645 and 650 that serve the function described herein below.

In the example shown here, OFDMA network 110 comprises a homogeneous zone 105. In the particular example shown here, the homogeneous zone 105 comprises a certain portion of the OFDMA network 110 where a higher number of handoffs are expected. More particularly, the homogeneous zone 105 is a microcell or picocell network area where a higher density of base stations 110 has been provided to account for an expected higher number of mobile stations 120. For example, the homogeneous zone 105 may be a portion of a wide-ranging communication network covering a dense downtown area, a train station or a shopping mall. It is to be understood, however, that the homogeneous zone 105 may be any portion of the OFDMA network 110, not necessarily one with a higher density of base stations 110. Furthermore, the homogeneous zone 105 may comprise the entire OFDMA network 110.

Homogeneous zone 105 comprises a plurality of base station 110 sharing a zone specific signature governing the air interface channelization. For example, each base station 110 in the homogeneous zone 105 may share a common scrambling code and sub-channel structure. Within the homogeneous zone 105, a communication scheme that facilitates soft handoffs is implemented.

FIG. 2 illustrates the total transmission resources 200 available to the first base station 110A as defined over a range of frequency subcarriers over which the first base station 110A can communicate and a range of time slots 215 into which time is divided. Here the smallest individual unit or “pixel” that can carry a signal is a unit 225 of a single frequency subcarrier and single time slot combination. A set 215 of transmission resource blocks 220 occupies a portion of the total transmission resources 210 (available to the first base station 110A). As will be explained in more detail below, the transmission resource blocks 220 within the set 215 are reserved for communication using spreading codes not used outside the set 215. The base stations 110 comprise a memory element storing identification of each transmission resource block 220 in the set 215. Each transmission resource block 220 has at least one unit 225 of frequency subcarrier and time slot. In the example illustrated here, each transmission resource block 220 comprises nine units 225 and represents three time slots at three different frequency subcarriers. While it is not necessary that all base stations 110 in the homogeneous zone 105 have the same range of total transmission resources, (for example, some base stations 110 may be capable of transmission over a wider range of frequencies than others), all base stations 110 within the homogeneous zone 105 share knowledge of, and can communicate over, the set 215 of transmission resource blocks.

In the present example, a signal communicated within the homogeneous zone 105 is either sent wholly within the set 215 of transmission resources, or wholly outside the set 215. When a signal is sent within the set 215, it is a single transmission resource block 220, which will carry the signal. It is to be understood that in alternate embodiments, a plurality of transmission resource blocks 220 or a portion of a transmission resource block 220 may be assignable to a single signal.

In the example shown here, the base stations 110 in the homogeneous zone 105 communicate using a combination of OFDMA and TDMA and the total transmission resources 200 are defined over a the two dimensions of frequency subcarriers and time slots. However, it is to be understood that the base stations 110 may not employ TDMA or may employ TDMA only within, or only outside of, the set 215 of transmission resource blocks. As such, the total transmission resources 200 available to the first base station 110A may be wholly, or partially one-dimensional. The certain embodiments, the transmission resource blocks 220 may comprise only a frequency subcarrier, if TDMA is not used in the transmission resource block 220. In other embodiments, TDMA may be used on all the frequency subcarriers in the range 204 and the set 215 of transmission resource blocks 220 may extend throughout all the frequency subcarriers but only in one or more particular timeslots.

It is to be understood, that although each transmission resource block 220 in the set 215 are shown here in a cluster such that the set 215 forms a contiguous portion of the total transmission resources 200, the transmission resource blocks 220 may occupy any portion of the total transmission resources 200 and need not be arranged in a contiguous portion. Furthermore, although each transmission resource block 220 is shown here as contiguous segments of units 225, individual transmission resource blocks 220 may comprise nonadjacent units 225 such that they form noncontiguous segments. Furthermore, although each transmission resource block 220 is shown here as having the same dimensions, it is to be appreciated that in an alternate embodiment, different transmission resource blocks 220 may have different dimension for carrying the same bandwidth, or may have different dimensions corresponding to different bandwidths. In the latter case, different transmission resource blocks 220 may be intended for reserved types of communication. It is also to be appreciated that in a simplified embodiment, the set 215 may comprise only one transmission resource block 220.

The OFDM zone 230 is the portion of the total transmission resources 210 not occupied by the set 215. Base stations 110 in the homogeneous zone 105 communicate over the OFDM zone 230 according to the orthogonal frequency-division multiplexing scheme of the OFDMA network 110. However, when communicating over transmission resources in the set 215, the base stations 110 additionally use a spreading code to encode, or “spread”, the signal. As such, a signal communicated over a transmission resource block 220 is a spread-spectrum frequency division multiplexed signal and occupies a greater bandwidth, having been spread with a spreading code, than if it had been sent in the OFDM zone 230. The purpose of encoding signals when transmitted over transmission resource blocks 220 is to permit multiple signals from occupying any one transmission resource block 220 without causing unrecoverable interference. To this end, any suitable code-division multiplexing scheme may be employed for communicating over transmission resource blocks 220. In a non-limiting example, CDMA-OFDMA is used to communicate over the transmission resource blocks 220 in the set 215, while OFDMA is used in the OFDM zone 230.

As will be described further below, the use of spreading codes in the transmission resource blocks 220, permits an improvement in soft handoffs. As such, soft handoffs preferably take place when communicating over transmission resource blocks 220 in the set 215, while communication in the OFDM zone 230 is preferably reserved for non-handoff conditions. However, it should be understood that while in certain embodiments, transmission resource blocks 220 in the set 215 may be reserved exclusively for soft handoff uses, in the present example, non-handoff communication can take place over transmission resource blocks 220, however soft handoffs are given priority in transmission resource blocks 220.

In a non-limiting example, base stations 110 in the homogeneous zone 105 communicate over transmission resource blocks 220 of the set 215 using spreading codes corresponding to a predetermined size of the transmission resource blocks 220. In this example, the spreading code used is selected from a pool of spreading codes known to satisfy a certain degree of orthogonality. The orthogonality of the spreading codes in the pool allow multiple signals to be successfully transmitted over the same transmission resource block 220 using different spreading codes, according to the principles of code-division multiplexing. In the present embodiment, each base station 110 comprises a memory element storing the pool of spreading codes.

In a non-limiting example, a mobile station 120 in the homogeneous zone 105 is associated with a particular spreading code from the pool of spreading codes. In this example, when a mobile station 120 enters the homogeneous zone 105, it is assigned a spreading code, which the mobile station 120 maintains at least until it leaves the homogeneous zone 105. The mobile station 120 may be assigned the spreading code by any suitable entity, such as by the base station 110 with which it first communicates in the homogeneous zone 105. The base station 110 may select a spreading code for the mobile station 120 in any suitable manner, such as randomly from the pool of spreading codes, and sends the mobile station 120 an instruction assigning the spreading code to it for use in communications over transmission resource blocks 220 in the set 215. In the present embodiment each mobile station 120 comprises a memory element for storing the mobile station 120's spreading code.

In addition to spreading codes, base stations 110 and mobile stations 120 may scramble signals prior to sending them according to known techniques. Scrambling may be performed for noise-resistance purposes, for eavesdropping-resistance purposes, or for reducing cross-interference with other mobile stations 120 or base stations 110. In the present example, each mobile station 120 is associated with a respective scrambling code which may be a large pseudorandom number and which may be permanently or semi-permanently associated with the mobile station 120. For each mobile station 120, this scrambling code can be stored in a memory element in the mobile station 120. Cross-interference between two signals scrambled can be effectively countered by scrambling them with such a scrambling code and applying descrambling upon reception. Base stations 110 communicating with mobile stations 120 may also be associated with respective scrambling code, or may use the scrambling codes of mobile stations 120 they communicate with. Base stations 110 may scramble communications in the OFDM zone 230, communications over transmission resource blocks 220 in the set 215, or both. In the present example, each mobile station 120 has a scrambling code of which base stations 110 are made aware such that it can be used for both uplink and downlink communication with base stations 110. To this end, base stations 110 may comprise a memory element for storing mobile stations 120's scrambling codes. Alternatively, base stations 110 and mobile stations 120 may each have their own respective scrambling codes, each using the other's (or, alternatively, their own) scrambling code for scrambling signals to be transmitted. A base station 110 or a mobile station 120 that has its own scrambling code may broadcast it, e.g. at regular intervals, to allow potential communication partners to be able to scramble destined for it and/or descramble signals received from it.

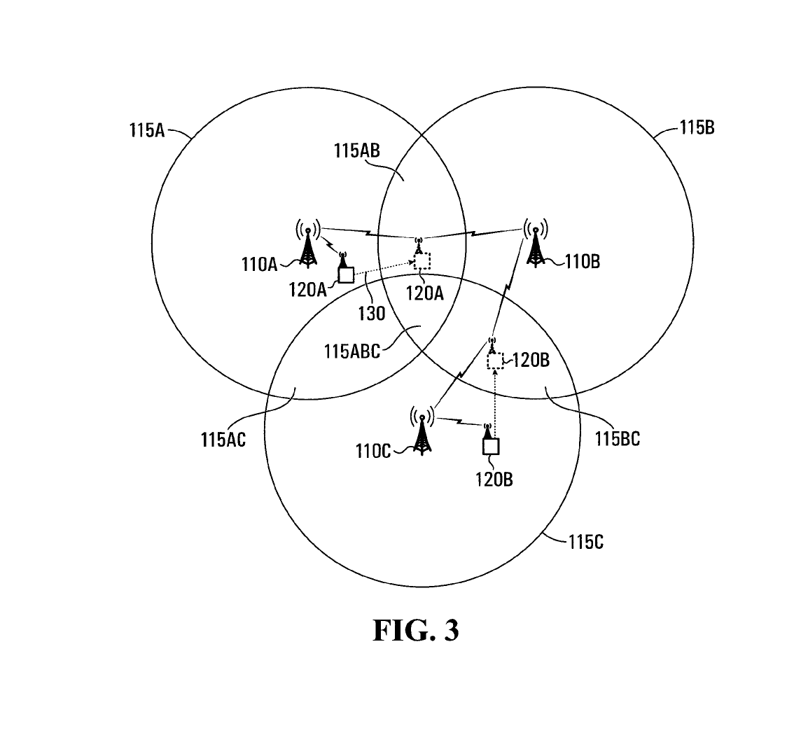

FIG. 3 shows a portion of the homogeneous zone 105 comprising three base stations 110, namely a first base station 110A, a second base station 110B and a third base station 110C. The base stations 110 have respective service areas 115, namely a first service area 115A corresponding to first base station 110A, a second service area 115B, corresponding to second base station 110B, and a third service area 115C, corresponding to third base station 110C. The service areas 115 include overlapping portions, in particular overlap area 115AB, where the first service area 115A overlaps with the second service area 115B, overlap area 115BC where the second service area 115B overlaps the third service area 115C, overlap area 115AC, where the first service area 115A overlaps the third service area 115C, and an overlap area ABC where the first service area 115A, the second service area 115B, and the third service area 115C all overlap. In the overlap areas, a mobile station 120 can be served by the base station of any of the overlapping service areas 115. Therefore a mobile station 120 in overlap area 115AB can be served by the first base station 110A or by the second base station 110B.

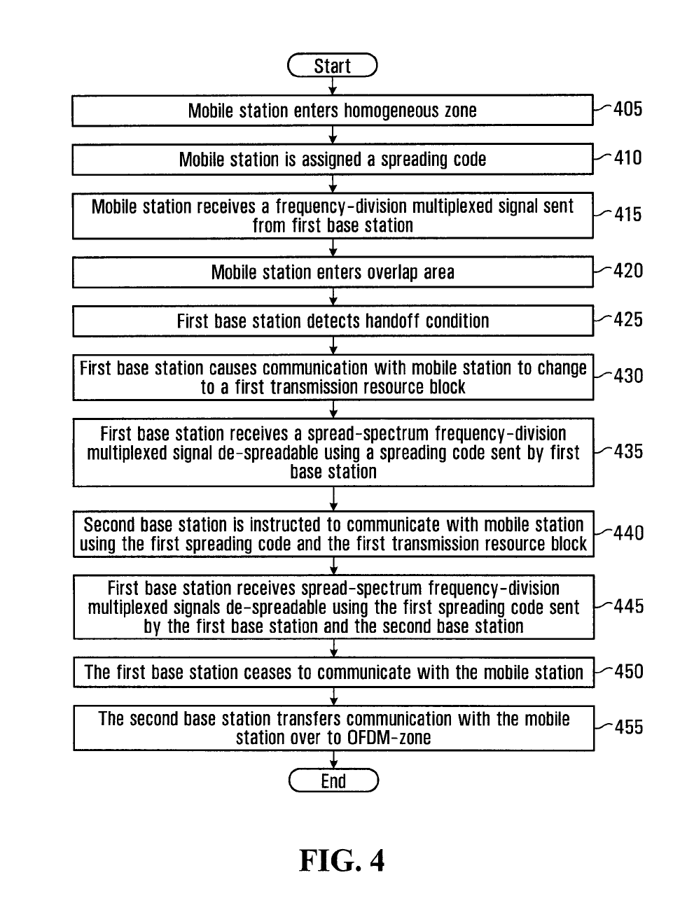

A soft handoff mechanism in accordance with a non-limiting example will now be described with reference to FIGS. 3 and 4. At step 405, a first mobile station 120A enters the homogeneous zone 105 in the service area 115 of the first base station 110A. For example, the first mobile station 120A may have been handed off to the first mobile station 120A or may have been turned on in the first service area 115A. Upon detecting the first mobile station 120A, at step 410, the first base station 110A selects a first spreading code from the pool of spreading codes and assigns it to the first mobile station 120A. In this example the first base station 110A selects and assigns the first spreading code on its own, but in alternate embodiment, this may be performed by another network entity in communication with the first base station 110A.

At step 415, the first mobile station 120A and the first base station 110A engage in communication over transmission resources in the OFDM zone 230. As part of this communication, the first base station 110A transmits a frequency-division multiplexed signal which in the present example is sent according to an OFDMA scheme and is received by the first mobile station 120A. The frequency-division multiplexed signal sent by the base station may be generated by the base station from a first data string comprising data to be frequency-division multiplexed and sent to the first mobile station 120A. The first data string may originate from the network interface having been received there from another network element. The first data string may undergo error-control encoding, such as forward error correction (FEC) encoding. Alternatively, the first data string may be received so coded. At this stage, the first mobile station 120A is in the first service area 115A, but not in an overlap area and therefore does not satisfy handoff conditions. Optionally, the first mobile station 120A also transmits a frequency-division multiplexed signal which is received by the first base station 110A. It is to be understood that while in the present example, the first mobile station 120A and first base station 110A communicate in the OFDM zone 230 while not in handoff condition, these could also communicate over a transmission resource block 220 of set 215 despite not being in a handoff condition.

At step 420, the first mobile station 120A moves towards the overlap area 115AB as illustrated in FIG. 3 by arrow 130.

At step 425, the fact that the first mobile station 120A is in the overlap area 115AB is recognized and handoff condition is detected. In this example, the first base station 110A detects the handoff condition on the basis of information received from the first mobile station 120A. More specifically, the first mobile station 120A itself receives a signal received from the second base station 110B and report its finding to the first base station 110A. For example, if the second base station 110B may emit a pilot signal or scrambling code broadcast, either one of which may be detected by the first mobile station 120A. The detection of such a signal, and optionally, a signal strength associated with it, may be sent from the first mobile station 120A to the first base station 110A to allow the first base station 110A to detect a handoff condition. In other embodiments, the first base station 110A may detect the soft handoff condition based on information received from another source such as another base station 110 or a centralized server that monitors the base stations 110 in the homogeneous zone 105. In one alternate embodiment, first mobile station 120A is detected by the second base station 110B when it enters the service area 115B. For example if the first mobile station 120A sends regular broadcasts of its scrambling code, and the second base station 110B may detect a such broadcast and inform first mobile station 120A's anchor base station 110 (in this case first base station 110A) that first mobile station 120A is within its communication range. In this alternate embodiment, each base station 110 may inform neighboring base stations 110 of the scrambling codes used by mobile stations 120 their respective service areas 115, such that neighboring base stations 110 need only monitor for those particular scrambling codes.

At step 430, the first base station 110A causes communication with the first mobile station 120A to change to a first transmission resource block 220′ in the set 215. The first transmission resource block 220 may be selected by the first base station 110A in any suitable manner, such as randomly, or may be assigned by a centralized server. This step only takes place if the first base station 110A and first mobile station 120A are not already communicating over a transmission resource block 220 in the set 215.

At this stage, represented by step 435, the first base station 110A and the first mobile station 120A are now communicating using a spreading code. The first base station 110A is sending a communication signal that is a spread-spectrum frequency-division multiplexed signal that is de-spreadable using the first spreading code, which in this example has been previously selected from the pool of spreading codes and assigned to the first mobile station 120A. The base station generates the spread-spectrum frequency-division multiplexed signal on the basis of a second data string also originating from the network interface having been received there from another network element. In this example, the second data string and the first data string both relate to a same communication session. In this example, the spread-spectrum frequency-division multiplexed signal is a CDMA-OFDMA signal that occupies a greater bandwidth than the OFDMA signal that was being sent in step 415. Like the first data string, the second data string may undergo error-control encoding, such as forward error correction (FEC). Alternatively, the second data string may be received so coded. Optionally, the first mobile station 120A may also send a spread-spectrum frequency-division multiplexed signal that is de-spreadable with a spreading code (e.g. with the same first spreading code, or with a different spreading code associated with the first base station) to the first base station 110A. In the present example, the CDMA-OFDMA communication between the first base station 110A and first mobile station 120A comprises the following steps: first data is forward error correction (FEC) coded, then spread over the first transmission resource block 220′ using the first spreading code and finally scrambled prior to transmission over subcarriers.

At step 440, the second base station 110B is instructed to being communicating with the first mobile station 120A using the first spreading code. In the present example, the second base station 110B is instructed to do so by the first base station 110A, which sends the second base station 110B an instruction signal comprising the first spreading code. The instruction signal also includes an indication of the first transmission resource block 220′ over which the first base station 110A is communicating with the first mobile station 120A. In the present example, the instruction signal also comprises the first mobile station 120A's scrambling code, although in alternate embodiments, the second base station 110B may obtain the first mobile station 120A's scrambling code from a broadcast signal from the first mobile station 120A itself.

At this stage, represented by step 445, the second base station 110B now has the information required to communicate with the first mobile station 120A and begins transmitting a signal intended for the first mobile station 120A over the same first transmission resource block 220′ over which the first base station 110A is communicating with the first mobile station 120A. The signal from the second base station 110B is also spread and scrambled according to the same codes as are being used between the first base station 110A and the first mobile station 120A. Advantageously, there is no need to coordinate between the first base station 110A and the second base station 110B to find a suitable frequency that is free for both base stations 110 at which to communicate with the first mobile station 120A. Indeed, since communication over the first transmission resource block 220′ are spread with the first spreading code, even if the second base station 110B is already communicating with another mobile station 120 over the first transmission resource block 220′, communicating with the first mobile station 120A will not interfere, since the communication is code-division multiplexed.

Turning back to FIG. 3, a second mobile station 120B may at this point enter overlap area 115BC from a third base station 110C causing the same chain of event that has been described above. Even if the second mobile station 120B is communicating over the same first transmission resource block 220′ when it enters the overlap area 115BC, the second base station 110B will be able to communicate with both the first mobile station 120A and the second mobile station 120B over the same first transmission resource block 220′ since the first mobile station 120A and second mobile station 120B are using different spreading codes. Furthermore, in the event of a spreading code collision, where first mobile station 120A and second mobile station 120B happen to have been assigned the same spreading code, their respective scrambling code will randomize the interference between these two mobile stations 120, thus preserving processing gain and allowing relatively interference-free communication nonetheless.

At step 450, the first mobile station 120A leaves the overlap area 115AB (remaining in the service area 115B) and communication between the first base station 110A and the first mobile station 120A cease. At step 455, the second base station 110B optionally transfers communications with the first mobile station 120A over to the OFDM zone 230.

Because the first base station 110A can instruct the second base station 110B to communicate with the first mobile station 120A without having to first negotiate for mutually acceptable transmission resources beforehand, the need for centralized scheduling for soft handoffs is eliminated. Thus the homogeneous zone 105 can take on a flat structure, effectively implementing distributed soft handoff scheduling. Alternatively, a centralized scheduler can be provided, but such a scheduler can be much simpler than those required in prior art OFMD networks. The centralized schedule could determine a transmission resource block 220 to be used for a soft handoff and inform the involved base stations 110. The scheduler could determining the transmission resource block 220 to use very easily since it would not need to ensure that only one transmission resource block 220 is used by any base station 110 at any given time.

The present system also allows simplified regular “hard” handoffs. In the example provided above, if hard handoffs are implemented, the first base station 110A can handoff the first mobile station 120A to second base station 110B needing only to inform the second base station 110B of the first transmission resource block 220′ over which it is communicating with the first mobile station 120A and of the first mobile station 120A's scrambling and spreading codes. The second base station 110B can then immediately being communicating with the first mobile station 120A with no more danger of interference with another mobile station 120 than in the soft handoff example. It will be appreciated that hard handoffs can be implemented with the same distributed scheduling or simplified centralized scheduling as described above in respect of soft handoffs.

In the present example, when a mobile station 120 is received in a handoff by a base station 110, it communicates with the base station 110 using the mobile station 120's own spreading code and scrambling code. If the communication between the mobile station 120 and the base station 110 is subsequently changed to the OFDM zone 230, the base station 110 pilot tones can be modulated using the mobile station 120's scrambling code, of which the base station 110 is already cognizant. The mobile station 120 scrambling code and spreading code remains unchanged and the handoffs are transparent to the mobile station 120.

In another embodiment, the system described above may be modified to place more responsibility into the mobile station 120's hands. In particular, although in the example provided above, the first base station 110A was responsible for detecting the soft handoff condition (from information obtained from the first mobile station 120A, from the second base station 110B or from a centralized server), this responsibility could be delegated to the first mobile station 120A. The first mobile station 120A could also be entrusted with selecting a transmission resource block 220 over which to communicate for a handoff, since this can be done without coordinating with the second base station 110B. In this alternate embodiment, the first mobile station 120A may then be responsible for instructing the second base station 110B or causing an instruction to be sent to the second base station 110B, to communicate with the first mobile station 120A using a particular spreading and/or scrambling code.

Although various embodiments have been illustrated, this was for the purpose of describing, but not limiting, the invention. Various modifications will become apparent to those skilled in the art and are within the scope of this invention, which is defined more particularly by the attached claims.

1. A method for execution by an apparatus comprising:
a. sending a first signal while not during a soft handoff, the first signal being a frequency division multiplexed signal comprising several subcarrier components;
b. sending over a second plurality of frequency subcarriers a second signal during the soft handoff, the second signal being a spread-spectrum frequency-division multiplexed signal comprising several subcarrier components.

2. The method of claim 1, wherein the second signal is de-spreadable with a spreading code.

3. The method of claim 2, wherein the second signal occupies a greater bandwidth than the first signal.

4. The method of claim 2, further comprising generating the first signal from a first data string and generating the second signal from a second data string.

5. The method of claim 4, wherein generating the second signal comprises applying the spreading code to the second data string.

6. The method of claim 5, wherein generating the second signal comprises applying the spreading code and a scrambling code, to the second data string.

7. The method of claim 4, wherein the first and second data strings both originate from a same origin.

8. The method of claim 4, wherein the first and second data strings are forward error correction-coded data strings.

9. The method of claim 2, wherein the second signal is sent over a transmission resource block, the transmission resource block comprising at least one of:
a. the second plurality of frequency subcarrier; and
b. at least one time slot.

10. The method of claim 9, wherein the first signal and the second signal are intended for a same mobile station.

11. The method of claim 10, wherein during the soft handoff the mobile station receives a third signal from a remote entity.

12. The method of claim wherein the third signal is a spread-spectrum frequency-division multiplexed signal spread using the spreading code and transmitted over the transmission resource block.

13. The method of claim 9, wherein the transmission resource block comprises at least one frequency subcarrier.

14. The method of claim 13, wherein the transmission resource block further comprises at least one time slot.

15. The method of claim 9, wherein the transmission resource block is a first transmission resource block selected from among a set of transmission resource blocks, each transmission resource block from the set of transmission resource blocks each comprising at least one of:
a. at least one frequency subcarrier; and
b. at least one time slot.

16. The method of claim 15, wherein the first signal is sent over transmission resources in a zone of the total available transmission resources not occupied by the set of transmission resource blocks of the total available transmission resources.

17-38. (canceled)

39. An apparatus for use in a communication network comprising:
a. a transmission interface;
b. a processing element in communication with the transmission interlace, the processing element being operative for:
i. causing the transmission interface to emit a frequency-division multiplexed signal comprising several subcarrier components while not during a soft handoff;
ii. causing the transmission interface to emit a spread-spectrum frequency-division multiplexed signal during the soft handoff, the spread-spectrum frequency-division multiplexed signal comprising several subcarrier components.

40-51. (canceled)

52. A method for execution by an apparatus comprising:
a. receiving a first signal prior to a soft handoff, the first signal being a frequency-division multiplexed signal comprising several subcarrier components;
b. receiving a second signal after the soft handoff, the second signal being a frequency-division multiplexed signal comprising several subcarrier components; and
c. receiving a third signal during the soft handoff, the third signal being a spread-spectrum frequency-division multiplexed signal comprising several subcarrier components.

53-77. (canceled)

78. An apparatus for use in a communication network comprising:
d. an input interface receiving signals;
e. a processing element in communication with the input interface, the processing element being operative for:
i. while not during a soft handoff, demodulating a first signal received by the input interface, the first signal being a frequency-division multiplexed signal comprising several subcarrier components;
ii. during a handoff, de-spreading and demodulating a second signal received by the input interface, the second signal being a spread-spectrum frequency-division multiplexed signal comprising several subcarrier components, the de-spreading being performed using a spreading code.

79-84. (canceled)

85. A method comprising:
a. sending first signal prior to detecting a handoff condition, the first signal being a frequency-division multiplexed signal comprising several subcarrier components;
b. detecting the handoff condition;
c. subsequent to detecting the handoff condition, sending a second signal, the second signal being a spread-spectrum frequency-division multiplexed signal comprising several subcarrier components.

86-87. (canceled)
